(19) United States
(12) Patent Application Publication
(10) Pub. No.: US 2025/0316087 A1
(43) Pub. Date: Oct. 9, 2025

(54) METHODS AND SYSTEMS FOR DETECTING BULLYING IN REAL TIME USING ARTIFICIAL INTELLIGENCE

(71) Applicant: Tyco Fire & Security GmbH, Neuhausen am Rheinfall (CH)

(72) Inventor: Kelvin H. XU, Lake Worth, FL (US)

(21) Appl. No.: 18/877,199

(22) PCT Filed: May 19, 2023
(86) PCT No.: PCT/US2023/067240

§ 371 Date: Dec. 19, 2024

Related U.S. Application Data
(60) Provisional application No. 63/366,740, filed on Jun. 21, 2022.

(51) Int. Cl. G06V 20/52; G06V 10/32; G06V 10/74; G06V 10/764; G06V 10/774; G06V 10/82; G06V 20/40

(52) U.S. Cl. CPC G06V 20/52; G06V 10/32; G06V 10/74; G06V 10/764; G06V 10/774; G06V 10/82; G06V 20/44

(57) ABSTRACT

A method and system may be configured to perform bullying detection using a three dimensional enhanced convolution neural network (3D enhanced CNN). In some aspects, method includes acquiring, from a video camera by a processor, a live video stream of a monitored area; preprocessing, by the processor, the video stream into a normalized low resolution video stream; applying, by the processor, 3D enhanced CNN to the normalized low resolution video stream to detect bullying in the normalized low resolution video stream; transmitting, by a transceiver communicatively coupled with the processor, a notification in response to detecting bullying. The 3D enhanced CNN includes 2 dimensional video and a third dimension in time.

### CROSS-REFERENCE TO RELATED APPLICATIONS

The application claims the benefit of U.S. Provisional Application No. 63/366,740, filed Jun. 21, 2022, which is herein incorporated by reference.

### BACKGROUND

### Statement of the Technical Field

The present disclosure relates generally to detecting bullying. More particularly, the present disclosure relates to implementing systems and methods for detecting bullying in real time using artificial intelligence.

### Description of the Related Art

Bullying may lead to pain and suffering among others. Conventional systems and methods for detecting bullying cannot achieve high performance (precision and recall) and real-time results simultaneously. Conventional systems and methods typically use machine learning, e.g., principle compound analysis (PCA) or k-nearest neighbor (KNN), with precision and recall not being high enough to be used effectively. Thus, there is a need for a system and method for real-time bullying detection using artificial intelligence.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure provides systems, apparatuses, and methods for detecting bullying using three dimensional enhanced convolution neural network (3D enhanced CNN). In an aspect, a method for detecting bullying may comprise: acquiring, from a video camera by at least one processor, a live video stream of a monitored area; preprocessing, by the at least one processor, the video stream into a normalized low resolution video stream; applying, by the at least one processor, 3D enhanced CNN to the normalized low resolution video stream to detect bullying in the normalized low resolution video stream; transmitting, by a transceiver communicatively coupled with the at least one processor, a notification in response to detecting bullying. The 3D enhanced CNN includes 2 dimensional video and a third dimension in time.

The present disclosure includes a system having devices, components, and modules corresponding to the steps of the described methods, and a computer-readable medium (e.g., a non-transitory computer-readable medium) having instructions executable by at least one processor to perform the described methods. In some aspects, non-transitory computer-readable media may exclude transitory signals.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example environment for detecting bullying in accordance with aspects of the present invention.

FIG. 2 is a high level block diagram of a bullying detection architecture in accordance with aspects of the present invention.

FIG. 3 is a block diagram of a video stream and acquisition and processing system in accordance with aspects of the present invention.

FIG. 4 is a flow diagram of video stream preprocessing in accordance with aspects of the present invention.

FIG. 5 is a flow or layer diagram of a two-dimensional convolution neural network (2D CNN) architecture.

FIG. 6 is a flow or layer diagram of a three-dimensional enhanced convolution neural network (3D enhanced CNN) architecture in accordance with aspects of the present invention.

FIG. 7 is a detailed flow or layer diagram of a 3D enhanced CNN architecture in accordance with aspects of the present invention.

FIG. 8 is a high-level methodology for bullying detection in accordance with aspects of the present invention.

FIG. 9 is a flow diagram for bullying detection in accordance with aspects of the present invention.

FIG. 10 is block diagram of an example of a computing device configured to detect bullying in accordance with aspects of the present invention.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Implementations of the present disclosure provide systems, methods, and apparatuses that provide detecting bullying in real time using artificial intelligence. These systems, methods, and apparatuses will be described in the following detailed description and illustrated in the accompanying drawings by various modules, blocks, components, circuits, processes, algorithms, among other examples (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, among other examples, whether referred to as software, firmware, middleware, microcode, hardware description language, or otherwise.

The present application is directed to system and methods for detecting bullying. As used herein, “bullying” includes verbal, physical, and/or social behavior of one person seeking to coerce, harm, or intimidate another person. A camera may capture a live video stream of a monitored area. The live video stream is provided to an edge device which uses a three dimensional enhanced convolution neural network (3D enhanced CNN) or deep neural network (DNN) to detect the bullying. More specifically the 3D enhanced CNN may recognize actions related to bullying, e.g., school bullying. In one or more embodiments, an enhanced MobileNet-V2 is scaled from two dimensions to three dimensions (e.g., with the third dimension being time or frames). By using the 3D enhanced CNN, the systems and methods are able to save computational costs and keep the memory small. As a result, the systems and methods are able to ensure embedded real-time detection of bullying.

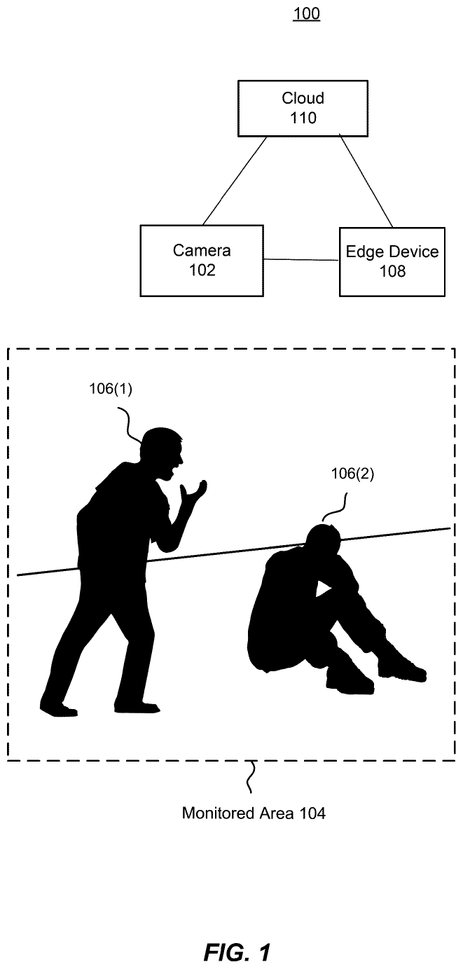

Referring to FIG. 1, an example environment for detecting bullying in accordance with aspects of the present invention is illustrated. The environment 100 can be a school (e.g., classroom, playground, hallway, etc.), work area of a company, restaurant, entertainment facilities, sports facilities, transportation system (e.g., bus, subway, airplane, trains, etc.), or any other area that is monitored for bullying. As shown, a camera 102 may capture a live video stream of a monitored area 104. For example, the camera 102 captures a live video stream of a school playground where two persons 106(1), 106(2) are interacting. More specifically, person 106(1) may be a student that is bullying person 106(2), who is also a student. It should be understood, however, that the two persons 106(1), 106(2) may be any persons. The camera 102 may be mounted to a pole, a building or any other object suitable to mount a camera. The camera 102 may include a transceiver (not shown) for transmitting the live video stream to an edge device (e.g., a processor) 108. The transmitted live video stream to the edge device 108 may be transmitted via one or more of a wired network or a wireless network. The edge device 108 may receive, via a transceiver (not shown), the live video stream and processes the received live video stream to detect bullying. If the edge device 108 detects bullying, a transceiver may transmit a notification or notification message to one or more people. The transmitted bullying notification may be transmitted via one or more of a wired network or a wireless network. For example, the edge device 108 may transmit a bullying notification message to one or more school personnel. The one or more people who receive the bullying notification may take action to stop and/or address the bullying. The bullying notification may be a text message, an email, or any other suitable message. The camera 102 and/or edge device 108 may transmit the live video stream to the cloud 110. For example, the edge device may transmit a segment of the live video stream which contains the detected bullying to the cloud 110 for training purposes as discussed below in more detail. The transmitted live video stream to the cloud may be transmitted via one or more of a wired network or a wireless network. The camera 102, the edge device 108 or a remote processor (not shown) may perform the bullying detection.

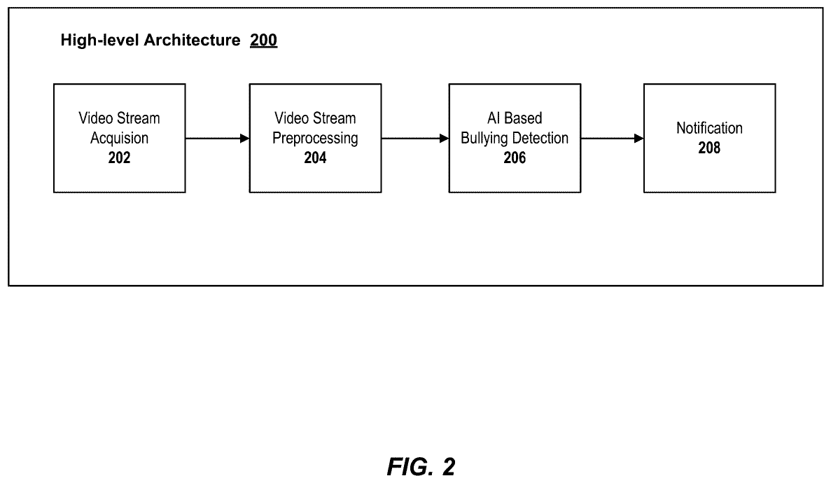

Referring to FIG. 2, a high level block diagram of the bullying detection architecture in accordance with aspects of the present invention is illustrated. As shown, the high level architecture 200 includes video stream acquisition 202, video stream preprocessing 204, artificial intelligence (AI) bullying detection 206 and notification 208. The video stream acquisition 202 may include receiving a live video stream from the camera 102 of an environment, e.g., school playground. The live video stream is preprocessed to assist in the bullying detection. The AI based bullying detection is performed and if bullying is detected a notification is sent to one or more people (e.g., school personnel).

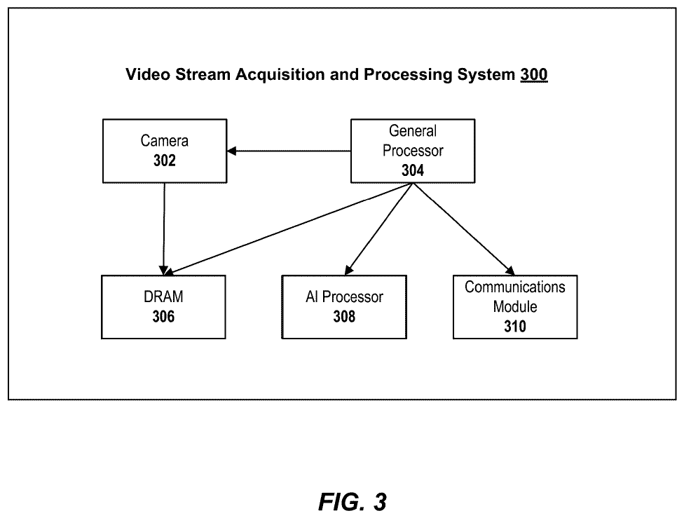

Referring to FIG. 3, a block diagram of hardware for the video stream and acquisition and processing system in accordance with aspects of the present invention is illustrated. As shown, the video stream acquisition and processing system 300 may include a camera 302, general processor 304, dynamic random access memory (DRAM) 306, artificial intelligence (AI) processor 308, communications module 310 and cloud 312. Although the hardware is shown as separate components, one or more of the general processor 304, DRAM 306, AI processor 308 and communications module 310 may be part of the camera 302 or an edge device (e.g., edge device 108). In another embodiment, the DRAM 306, AI processor 308 and communication module 310 may be part of the general processor 304 or edge device 108. In some embodiments, the general processor 304 may perform some or all of the processing attributed to the AI processor 308. In some embodiments, the AI processor 308 may perform some or all of the processing attributed to the general processor 304. The camera 302 (e.g., camera 102) may capture a live video stream of a monitored area 104 (e.g., a school playground). The camera 302 may have a video frame rate, such as five (5) frames per second, and a raw video resolution, such as 1920×1080 pixels. The general processor 304 may receive the live video stream from the camera 302. The camera 302 and/or the general processor 304 may store the live video stream in the DRAM 306 and/or any other suitable memory. The AI processor 308 may process the live video stream. In response to the AI processor 308 detecting bullying, the AI processor 308 may provide an indication of bullying to the general processor 304 which may transmit a notification to one or more people (e.g., school personnel) of the detected bullying via the communication module 310. The communication module 310 may be a transceiver that transmits the notification via one or more of a wireless network or a wired network. A transceiver may include a receiver and transmitter. In one or more embodiments the transceiver may be replaced with one or more receivers and one or more transmitters. The general processor 304 may provide one or more segments of the live video stream in which bullying was detected to the cloud 110 via the communications module 310. The cloud 110 may store and provide such segments to other bullying detection systems to assist in training such systems.

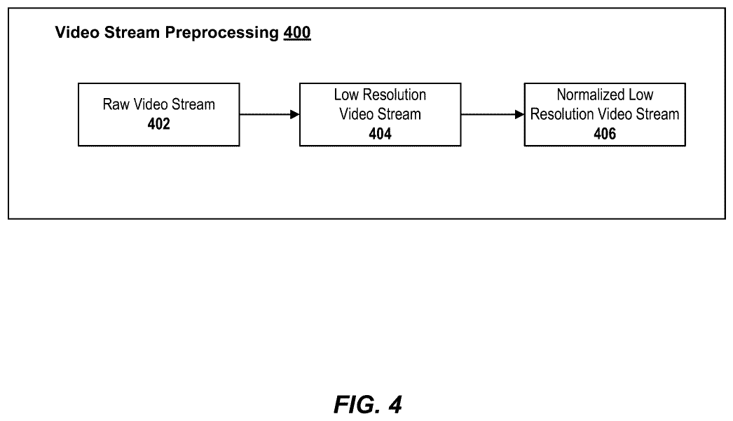

Referring to FIG. 4, a flow diagram of the video stream preprocessing in accordance with aspects of the present invention is illustrated. As shown, the video stream preprocessing flow 400 may include receiving a raw video stream 402. For example, the general processor 304 may receive the raw video stream from a camera 102, 302. The raw video stream may be converted into a low resolution video stream 404. For example, the general processor 304 may convert the raw video stream having a high resolution of 1920×1080 pixels down to a low resolution video stream of 224×224 pixels. The raw video stream may be sampled in two second increments which is ten frames. The low resolution video stream may then be normalized into a normalized low resolution video stream 406. For example, the general processor 304 normalizes the low resolution video stream into a normalized low resolution video stream. By normalizing the low resolution video stream, a scaling technique is implemented to change the low resolution video stream to a common scale. For example, the scaling can be from 0 to 1 or −1 to +1. The normalization is applied to the three red green blue (RGB) channels of the low resolution video stream.

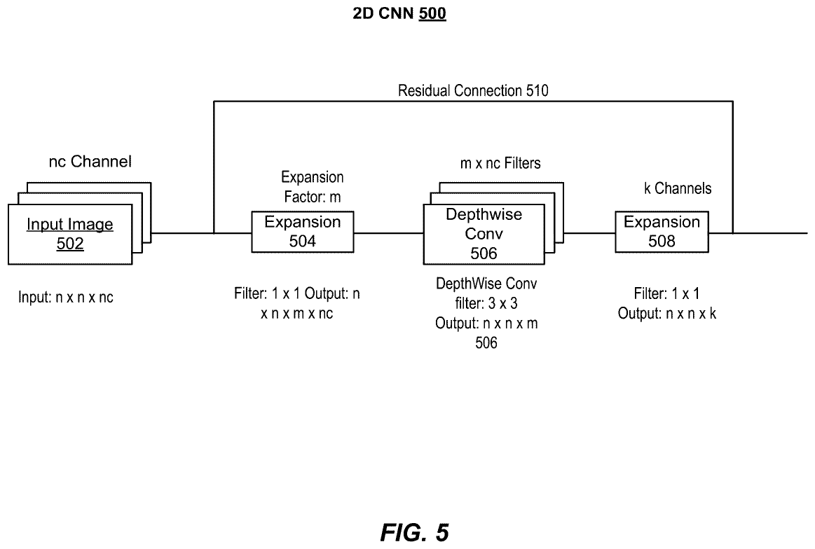

Referring to FIG. 5, a flow or layer diagram of a two-dimensional convolution neural network (2D CNN) architecture is illustrated. For example, the 2D CNN 500 may be a MobileNet-V2Architecture which is a product by Google (Mountain View, CA). As shown, at block 502, an input image (shown with the three RGB channels) is provided to the 2D CNN 500. The input image has parameters n×n×nc with each n representing the resolution (e.g., height and width resolutions of the input image) and nc being the number of channels (e.g., the three RGB channels). At block 504, an expansion operation is performed to expand the number of channels nc in the data (e.g., input image) with expansion factor m to m×nc channels. A purpose of the expansion layer is to learn rich features. The expansion operation or layer includes applying pointwise convolution 1×1 to each of the channels of the input images to expand and produce intermediary information (e.g., intermediary tensor or volume). Each of the pointwise filters is a 1×1 and the output of this layer is n×n×m×nc. At block 506, depth-wise convolution is applied to the output of the previous layer (e.g., block 504) using m×nc filters with each of the filters being a 3×3 filter and produces an output of n×n×m×nc. At block 508, projection is applied to the output of the previous layer (e.g., block 506) using m×nc filters having the pointwise convolution with a 1×1 filter to product an output of n×n×k. The purpose of the projection layer is to reduce the number of output channels which reduces the size of the memory that is needed. If the output of linear transformation of the pointwise convolution from block 508 is close to zero, then a residual connection 510 is used in which the input image becomes the input to the non-linear ReLU6 in block 508.

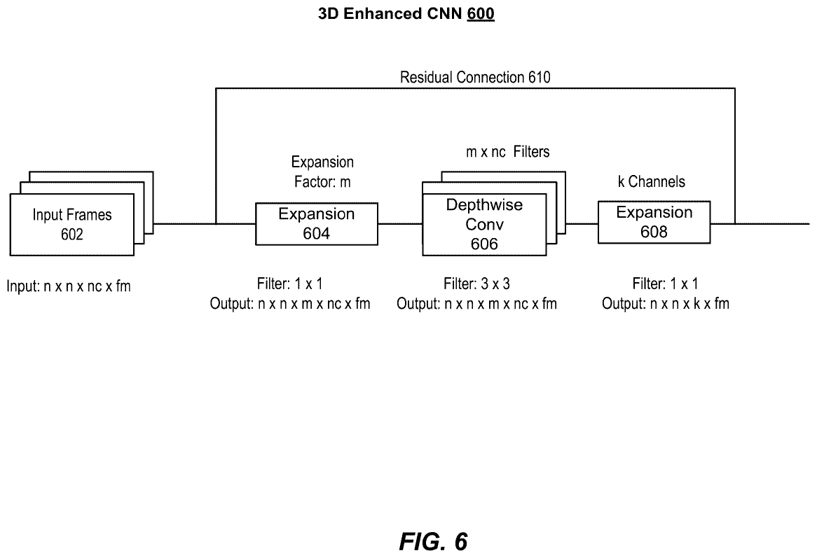

Referring to FIG. 6, a flow or layer diagram of a three-dimensional enhanced convolution neural network (3D enhanced CNN) architecture in accordance with aspects of the present invention is illustrated. In order to provide high precision bullying detection in real time, the 2D CNN 500 of FIG. 5 is scaled up to a 3D enhanced CNN 600 with the third dimension being frames or time. As shown, at block 602, an input image (shown with the three RGB channels) is provided to the 3D enhanced CNN 600. The input image has parameters n×n×nc×fm with each n representing the resolution (e.g., height and width resolutions of the image), the nc being the number of channels (e.g., the 3 RGB channels) and the fm being the number of frames. At block 604, an expansion operation is performed on each frame to expand the number of channels nc in the data (e.g., input image) with expansion factor m to m×nc channels. The expansion operation or layer includes applying pointwise convolution 1×1 to each of the channels of the input image to expand and produce intermediary information (e.g., intermediary tensor or volume). Each of the pointwise filters is a 1×1 filter and the output of this layer is n×n×m×nc×fm. At block 606, depth-wise convolution is applied to the output of the previous block using m×nc filters with each of the m×nc filters being a 3×3 filter and produces an output of n×n×m×nc×fm with m being the expansion factor from the previous expansion layer. At block 608, projection is applied to the output of the previous block using m×nc filters having the pointwise convolution with a 1×1 filter to product an output of n×n×k×fm. If the output of linear transformation of the pointwise convolution from block 608 is closed to zero, then a residual connection 610 is used in which the input image becomes the input to the non-linear ReLu6 in block 608.

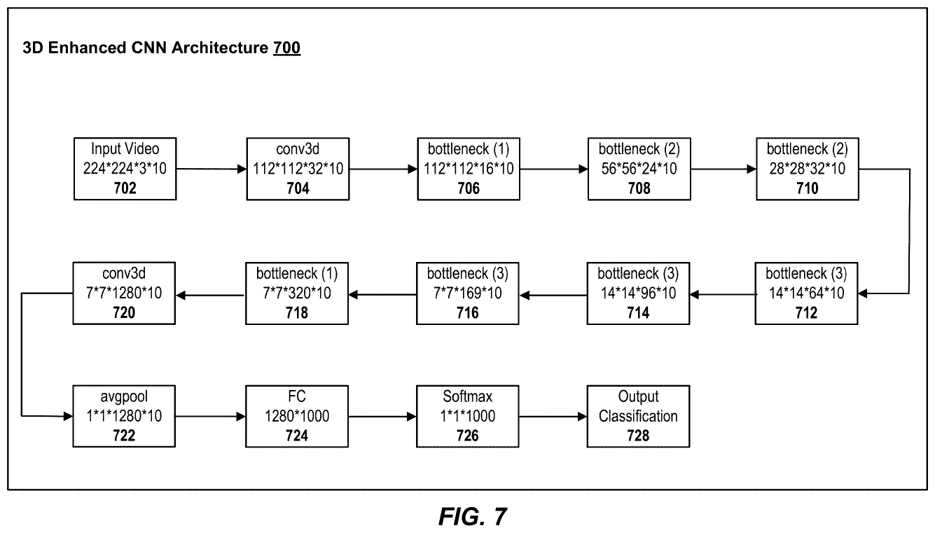

Referring to FIG. 7, a detailed a flow or layer diagram of a 3D enhanced CNN architecture in accordance with aspects of the present invention is illustrated. Most of the block in this figure includes four numbers with the first two numbers being the height resolution and width resolution, the third number is number of channels and the fourth number is the number of frames. The method or flow 700 begins at block 702. In block 702, input frames, e.g., ten frames from the normalized low resolution video stream, is received. The low resolution video stream is 224×22×3×10. In block 704, a 3D convolution operation is performed with the output being 112×112×32×10. In block 706, a bottleneck operation is performed with one bottleneck being applied and the output being 112×112×16×10. Here we use the expansion factor m=6 internally to learn more features for all of bottlenecks in this architecture. In block 708, another bottleneck operation is performed with two bottlenecks being applied and the output being 56×56×24×10. In block 710, another bottleneck operation is performed with two bottlenecks being applied and the output being 28×28×32×10. In block 712, another bottleneck operation is performed with three bottlenecks being applied and the output being 14×14×64×10. In block 714, another bottleneck operation is performed with three bottlenecks being applied and the output being 14×14×96×10. In block 716, another bottleneck operation is performed with three bottlenecks being applied and the output being 7×7×169×10. In block 718, another bottleneck operation is performed with one bottleneck being applied and the output being 7×7×320×10. In block 720, a 3D convolution operation is performed with the output being 7×7×1280×10. In block 722, an average pool operation is performed with the output being 1×1×1280×10. In block 724, a full connection operation is performed with the output being 1280×1000. In block 726, a soft max operation is performed with the output being 1×1×1000. In block 728, an output classification is performed. For example, the output classification may be the detection of one action of bullying (e.g., kicking) or no detection of bullying.

In order to provide high precision bullying detection in real time, the 2D CNN is scaled up to a 3D enhanced CNN with the third dimension being frames or time. The 3D enhanced CNN is applied to each frame with all of the frames being connected in the full connection (FC) operation (e.g., block 424). The 3D enhanced CNN is used to fit the embedded hardware (e.g., processor and memory) of the detection requirements. During the application of the 3D enhanced CNN, the resolutions are changed and the number of bottlenecks are changed. For example, the default MobileNet-V2 architecture typically uses 17 bottlenecks and the 3D enhanced CNN of FIG. 7, used 15 bottlenecks which provides about a 10% memory savings. More specifically, the number of bottlenecks in block 710 is reduced from three to two bottlenecks and the number of bottlenecks in block 712 is reduced from four to three bottlenecks. The width of the 3D enhanced CNN is selected by using hyper-parameters k, m (expansion factor: 6) and fm (number of frame: 10) for optimal performance. By using the 3D enhanced CNN one or more of the following advantages may be achieved: computational cost and memory savings, improve real-time performance, improve accuracy and avoid or reduce false alarms, fits into various hardware configurations and continued on-line training and deployment can be achieved.

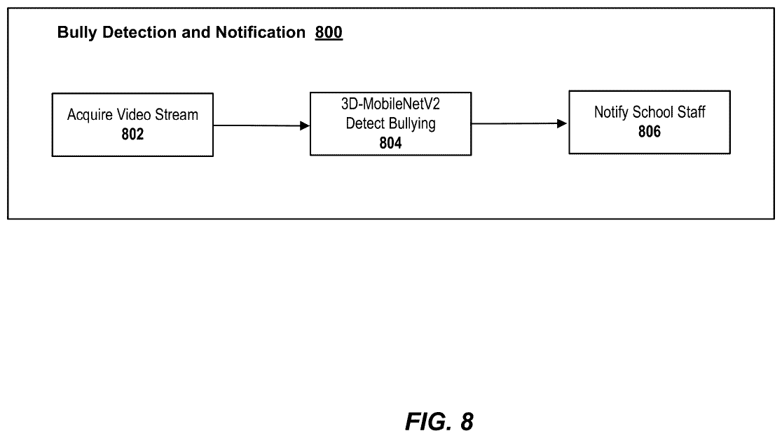

Referring to FIG. 8, a high-level methodology for bullying detection in accordance with aspects of the present invention is illustrated. As shown, the methodology 800 may include a camera capturing a video stream at block 802. The video stream may be provided to a 3D enhanced CNN to detect bullying at block 804. If bullying is detected, a notification may be transmitted at block 806. For example, a bullying notification may be transmitted to one or more people, e.g., school employees. The bullying notification may be transmitted wirelessly.

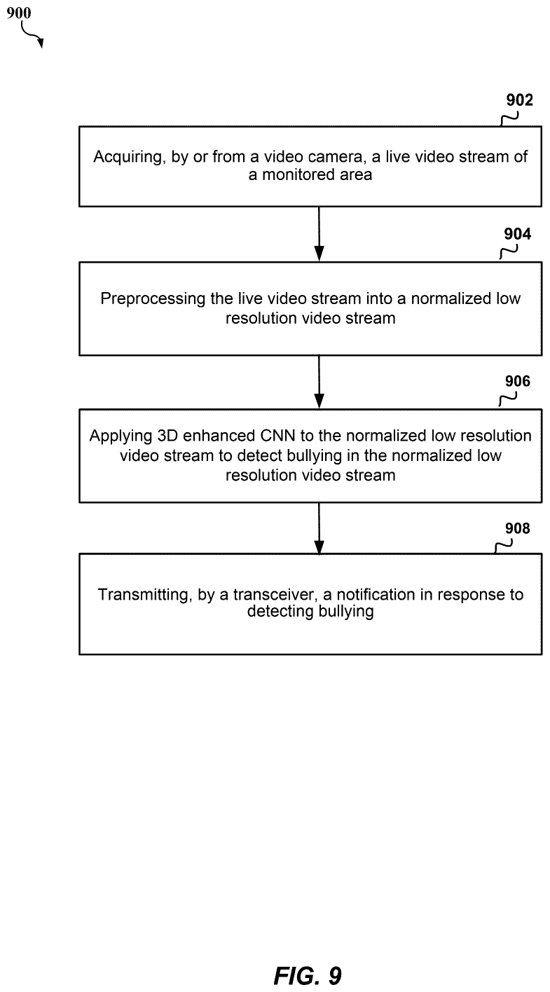

Referring to FIG. 9, a flow diagram for bullying detection in accordance with aspects of the present invention is illustrated. The method 900 may be performed by one or more components of the camera 102, edge device 108, the computing device 1000, or any device/component described herein according to the techniques described with reference to FIGS. 1-8 and 10.

At block 902, the method 900 includes acquiring, by or from a video camera, a live video stream of a monitored area. For example, the video camera 102 may capture a live video stream of a monitored area 104. In some aspects, the video camera 102 may transmit the live video stream to an edge device 108. At least one processor of the edge device 108, e.g., the general processor 304 and/or the AI processor 308, may receive the live video stream. In some aspects, at least one processor of the camera 102 may acquire the live video stream of the monitored area. Accordingly, the camera 102, the edge device 108, the general processor 304 and/or the AI processor 308 may provide means for acquiring, by or from a video camera, a live video stream of a monitored area.

At block 904, the method 900 includes preprocessing the live video stream into a normalized low resolution video stream. For example, at least one processor of the edge device 108, e.g., the general processor 304 and/or the AI processor 308, may preprocess the live video stream into a normalized low resolution video stream. In some aspects, at least one processor of the camera 102 may preprocess the live video stream into a normalized low resolution video stream. Accordingly, at least one processor of the camera 102, the edge device 108, the general processor 304 and/or the AI processor 308 may provide means for preprocessing the live video stream into a normalized low resolution video stream. For example, the raw video resolution of the live video stream may be 1920×1080 pixels and resolution of the normalized low resolution may be 224×224 pixels.

At block 906, the method 900 includes applying 3D enhanced CNN to the normalized low resolution video stream to detect bullying in the normalized low resolution video stream. For example, at least one processor of the edge device 108, e.g., the general processor 304 and/or the AI processor 308, may apply 3D enhanced CNN to the normalized low resolution video stream to detect bullying in the normalized low resolution video stream. In some aspects, at least one processor of the camera 102 may apply 3D enhanced CNN to the normalized low resolution video stream to detect bullying in the normalized low resolution video stream. Accordingly, the camera 102, the edge device 108, the general processor 304 and/or the AI processor 308 may provide means for applying 3D enhanced CNN to the normalized low resolution video stream to detect bullying in the normalized low resolution video stream.

At block 908, the method 900 includes transmitting, by a transceiver, a notification in response to detecting bullying. For example, a transceiver communicatively coupled with at least one processor, e.g., at least one processor of the edge device 108, such as the general processor 204 and/or the AI processor 308, may transmit the notification in response to detecting bullying. In some aspects, a transceiver communicatively coupled with the at least one processor of the camera 102 may transmit the notification in response to detecting bullying. Accordingly, a transceiver of the camera 102 or edge device may provide the means to transmit the notification in response to detecting bullying. The notification may be sent to one or more people. For example, the one or more people may include personnel associated with the monitored area and/or security or law enforcement personnel.

The 3D enhanced CNN may be built using a dataset having bullying actions and normal human actions (e.g., non-bullying actions). The bullying actions may include slapping, punching and kicking. The bullying actions may include actions with weapons, such as pointing a gun or wielding a knife. The non-bullying action may including walking, running, standing, falling or any other actions that are not performed to intimidate another person. The bullying actions and non-bullying actions may include video segments. The video segments may be from UCF101, Kinetic dataset, Sport1M, YouTube, etc. The video segments may be 2 second video clips to annotate an action. The video clips may have a set frame rate, such as five frames per second. Thus, a total of 10 frames may be used to detection an action. The datasets may comprise three data sets: training set, test set and validation set.

The data sets may be used for training and inference. Graphical processing units (GPUs) may the datasets to train the 3D enhanced CNN. The training may be performed in batches. The training may be continuous or on-going. For example, video segments showing bullying actions may be uploaded to the cloud and the 3D enhanced CNN may use the video segments on the cloud for training. Bullying detection or inference may occur in real time using live video streams with less than one second for one action in two seconds of the video stream. A moving window of five frames may be used to detect bullying action from a continuous live video stream.

In some aspects, the 3D enhanced CNN may be trained using a training dataset that includes a plurality of videos clips that are more than two seconds long (to enable the analysis of audio). Each video clip may be labelled with a particular bullying action or may be labelled as “no bullying.” In some aspects, the videos may include an audio portion and a visual portion. Because it is possible that physical sports such as football, rugby, boxing, etc., may include actions that appear to be bullying, the audio portion of the video clips may provide greater context to the scene. For example, a standard football action of pushing may be linked with an audio portion including a whistle, the sound of running, the sound of a crowd, etc. A video clip including this visual and audio may be marked as “no bullying” in the training dataset. Accordingly, the 3D enhanced CNN may extrapolate information from this dataset and avoid marking a video clip of a boxing match in a school gymnasium as “bullying.” This is because the video clip may feature audio that includes the sound of a bell, a crowd, a referee, etc. Furthermore, video clips depicting bullying may include audio that includes keywords such as “loser,” “hate,” “help,” etc., and may include sounds of laughter, cries of pain, sobbing, etc. As a result, the 3D enhanced CNN may correctly identify bullying clips using the audio information.

Thus, the 3D enhanced CNN may identify audio-based features linked with visual features by timestamp (e.g., sounds of crying one second after frames depicting a punch being landed) to identify bullying. These audio-based features linked with visual features by timestamp further enable the 3D enhanced CNN to avoid classifying physical activities (e.g., sports games) as possible bullying.

More specifically, for each video clip, the 3D enhanced CNN may be configured to detect a plurality of keywords in the audio portion (e.g., “ouch,” “ahhh,” “help,” “shutup,” etc.) and classify an action over a plurality of frames (e.g., a kick, a punch, etc.). In some aspects, the 3D enhanced CNN may further detect soundbites such as crying, screaming, etc., and interpret those as keywords such as “crying,” “screaming,” etc. In some aspects, the 3D enhanced CNN may further determine tones in the audio portion (e.g., “angry,” “sad,” etc.). Based on the plurality of keywords, tone, and/or the classified action, the 3D enhanced CNN may determine whether bullying is occurring in a video clip. More specifically, the 3D enhanced CNN is trained to detect keyword and action combinations matching historic bullying keywords and bullying actions. As a result, the extracted keywords and classified actions may be determined in various layers of the 3D enhanced CNN and matched against historic bullying keywords and bullying actions albeit in different embeddings of said layers.

In some aspects, the 3D enhanced CNN may be a generative adversarial network (GAN). As used herein, in some aspects, a GAN consists of two ML networks (e.g., two neural networks): a generator that creates new data and a discriminator that evaluates the data. Further, the generator and discriminator may work together, with the generator improving its outputs based on the feedback it receives from the discriminator until it generates content that is indistinguishable from real data. In some aspects, the first sub-model may be a discriminator based on operating policies and the second sub-model may be a generator based on historic bullying event and response information, and the first sub-model may be used to train the second sub-model.

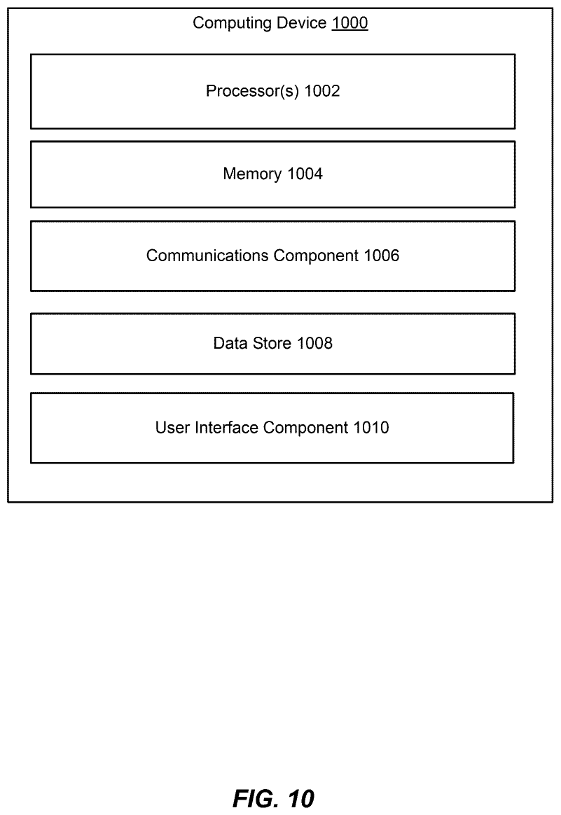

Referring to FIG. 10, a computing device may implement all or a portion of the functionality described herein. The computing device 1000 may be or may include or may be configured to implement the functionality of the camera 102 or the edge device 108. The computing device 1000 includes at least one processor 1002 which may be configured to execute or implement software, hardware, and/or firmware modules that perform any functionality described herein. For example, the at least one processor 1002 may be configured to execute or implement software, hardware, and/or firmware modules that perform any functionality described herein with reference to the one or more of the camera 102, edge device 108, general processor 304, AI processor 308 or any other component/system/device described herein.

The at least one processor 1002 may be a micro-controller, an application-specific integrated circuit (ASIC), a digital signal processor (DSP), or a field-programmable gate array (FPGA), and/or may include a single or multiple set of processors or multi-core processors. Moreover, the at least one processor 1002 may be implemented as an integrated processing system and/or a distributed processing system. The computing device 1000 may further include a memory 1004, such as for storing local versions of applications being executed by the processor 1002, related instructions, parameters, etc. The memory 1004 may include a type of memory usable by a computer, such as random access memory (RAM), read only memory (ROM), tapes, magnetic discs, optical discs, volatile memory, non-volatile memory, and any combination thereof. Additionally, the at least one processor 1002 and the memory 1004 may include and execute an operating system executing on the processor 1002, one or more applications, display drivers, and/or other components of the computing device 1000.

Further, the computing device 1000 may include a communications component 1006 that provides for establishing and maintaining communications with one or more other devices, parties, entities, etc. utilizing hardware, software, and services. The communications component 1006 may carry communications between components on the computing device 1000, as well as between the computing device 1000 and external devices, such as devices located across a communications network and/or devices serially or locally connected to the computing device 1000. In an aspect, for example, the communications component 1006 may include one or more buses, and may further include transmit chain components and receive chain components associated with a wireless or wired transmitter and receiver, respectively, operable for interfacing with external devices.

Additionally, the computing device 1000 may include a data store 1008, which can be any suitable combination of hardware and/or software, that provides for mass storage of information, databases, and programs. For example, the data store 1008 may be or may include a data repository for applications and/or related parameters not currently being executed by processor 1002. In addition, the data store 1008 may be a data repository for an operating system, application, display driver, etc., executing on the processor 1002, and/or one or more other components of the computing device 1000.

The computing device 1000 may also include a user interface component 1010 operable to receive inputs from a user of the computing device 1000 and further operable to generate outputs for presentation to the user (e.g., via a display interface to a display device). The user interface component 1010 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 1010 may include one or more output devices, including but not limited to a display interface, a speaker, a haptic feedback mechanism, a printer, any other mechanism capable of presenting an output to a user, or any combination thereof.

Further, while the figures illustrate the components and data of the edge device 108 as being present in a single location, these components and data may alternatively be distributed across different computing devices and different locations in any manner. Consequently, the functions may be implemented by one or more service computing devices, with the various functionality described herein distributed in various ways across the different computing devices 1000. Multiple computing devices 1000 may be located together or separately, and organized, for example, as virtual servers, server banks and/or server farms. The described functionality may be provided by the servers of a single entity or enterprise, or may be provided by the servers and/or services of multiple different buyers or enterprises.

What is claimed is:

1. A method for detecting bullying, the method comprising:
acquiring, from a video camera by at least one processor, a live video stream of a monitored area;
preprocessing, by the at least one processor, the live video stream into a normalized low resolution video stream;
applying, by the at least one processor, 3 dimensional enhanced convolution neural network (3D enhanced CNN) to the normalized low resolution video stream to detect bullying in the normalized low resolution video stream; and
transmitting, by a transceiver communicatively coupled with the at least one processor, a notification in response to detecting bullying,
wherein the 3D enhanced CNN includes 2 dimensional video and a third dimension in time.

2. The method of claim 1, wherein the 3D enhanced CNN is an enhanced MobileNet-V2 network.

3. The method of claim 1, wherein a video frame rate of the live video stream is 5 frames per second.

4. The method of claim 1, wherein raw video resolution of the live video stream is 1920×1080 pixels and resolution of the normalized low resolution is 224×224 pixels.

5. The method of claim 1, wherein the live video stream is sampled at 2 second increments comprising 10 frames.

6. The method of claim 1, wherein the live video stream is sampled using a moving window of 5 frames.

7. The method of claim 1, wherein applying the 3D enhanced CNN to the normalized low resolution video stream comprises normalizing 3 red green blue (RGB) channels.

8. The method of claim 1, wherein applying the 3D enhanced CNN to the normalized low resolution video stream comprises applying 15 bottlenecks.

9. The method of claim 8, wherein 2 bottlenecks are applied to a bottleneck operation having 28×28×32×10 parameters and 3 bottlenecks are applied to a bottleneck operation having 14×14×64×10 parameters.

10. The method of claim 1, wherein the monitored area is a school.

11. The method of claim 1, wherein the 3D enhanced CNN is a generative adversarial network comprising a first sub-model used to train a second sub-model.

12. The method of claim 1, wherein a training dataset of the 3D enhanced CNN comprises a plurality of video clips depicting labelled bullying and non-bully events.

13. The method of claim 12, wherein each of the plurality of video clips comprise an audio portion and a visual portion, and wherein the training dataset links the audio portion to the visual portion using timestamps, further comprising:
detecting a plurality of keywords in the audio portion; and
classifying an action in the visual portion.

14. The method of claim 13, wherein the 3D enhanced CNN is configured to detect the bullying based on a combination of the plurality of keywords and the action matching historic keywords and actions matching the bullying.

15. An edge device, comprising:
a memory storing computer-executable instructions; and
at least one processor coupled with the memory and configured to execute the computer-executable instructions to:
acquire a live video stream of a monitored area;
preprocess the live video stream into a normalized low resolution video stream;
apply 3 dimensional enhanced convolution neural network (3D enhanced CNN) to the normalized low resolution video stream to detect bullying in the normalized low resolution video stream; and
transmit, by a transceiver communicatively coupled to the at least one processor, a notification in response to detecting bullying,
wherein the 3D enhanced CNN includes 2 dimensional video and a third dimension in time.

16. The edge device of claim 15, wherein the 3D enhanced CNN is an enhanced MobileNet-V2 network.

17. The edge device of claim 15, wherein a video frame rate of the live video stream is 5 frames per second.

18. The edge device of claim 15, wherein raw video resolution of the live video stream is 1920×1080 pixels and resolution of the normalized low resolution is 224×224 pixels.

19. The edge device of claim 15, wherein the live video stream is sampled at 2 second increments comprising 10 frames.

20. The edge device of claim 11, wherein the monitored area is a school.

21. A non-transitory computer-readable device having instructions stored thereon that, when executed by at least one computing device, cause the at least one computing device to perform operations comprising:
acquiring, from a video camera, a live video stream of a monitored area;
preprocessing the live video stream into a normalized low resolution video stream;
applying 3 dimensional enhanced convolution neural network (3D enhanced CNN) to the normalized low resolution video stream to detect bullying in the normalized low resolution video stream; and
transmitting, by a transceiver, a notification in response to detecting bullying,
wherein the 3D enhanced CNN includes 2 dimensional video and a third dimension in time.
